(19) United States
(12) Patent Application Publication
(10) Pub. No.: US 2003/0135385 A1
(43) Pub. Date: Jul. 17, 2003

(54) Systems and methods for deploying profitable storage services

(75) Inventor: Wayne Karpoff, Alberta (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Yotta Yotta, Inc., Kirkland, WA

(21) Appl. No.: 10/291,849

(22) Filed: Nov. 7, 2002

Related U.S. Application Data
(63) Continuation-in-part of application No. 10/046,070, filed on Jan. 11, 2002.
(60) Provisional application No. 60/337,704, filed on Nov. 7, 2001.

(51) Int. Cl. G06F 17/60

(52) U.S. Cl. 705/1

(57) ABSTRACT

Systems and methods for delivering electronic data storage to consumers in an efficient, cost-effective way. A new storage networking paradigm, Utility Storage, is provided which addresses the specific needs of SSPs. Many characteristics of the Utility Storage model enable a new SSP business model to be implemented that is more profitable and growth orientated. An SSP using the Utility Storage model is able to provides storage to an end customer with a low entry cost threshold that encourages incremental consumption by the consumer. Additionally, using the Utility Storage model, the SSP is able to provide storage services to an end customer at a lower cost by amortizing the operating and infrastructure costs across a larger population of customers.

### CROSS-REFERENCES TO RELATED APPLICATIONS

This application is a continuation-in-part of U.S. patent application Ser. No. 10/046,070, “Storage Virtualization Systems and Methods”, filed Jan. 11, 2002, which is hereby incorporated by reference in its entirety for all purposes. This application also claims the benefit of U.S. Provisional Patent Application Serial No. 60/337,704, filed Nov. 7, 2001, which is hereby incorporated by reference in its entirety for all purposes.

### BACKGROUND OF THE INVENTION

Enterprises everywhere are feeling the strain on their IT infrastructures as the huge demand for storage continues to rapidly increase. Escalating capacity and bandwidth requirements cause costs to soar as resource-constrained IT organizations struggle to manage the complexity and sheer volume of data that must be stored, accessed, and protected. These issues have fueled the emergence of the Storage Service Provider (SSP) market where the business model is based on the superior business benefits of outsourced services. The premise is that an SSP, through economies of scale, innovative technology and efficient resource management, can offer its subscribers lower costs with higher qualities of service.

An SSP infrastructure must be designed to service numerous customers. The foundation should be scalable, agile, available and secure, but this is not always the case when SSPs deliver their services via platforms designed for use in an enterprise environment. Since an SSP infrastructure must facilitate the sharing of common resources among a subscriber base with divergent applications and unpredictable fluctuations in storage usage, issues of complexity, customer separation and scalability arise that were of little consequence in a traditional corporate data center.

Historically, attempts at making SSPs commercially viable have failed because traditional storage technologies offered no ability to lower operating costs through the safe amalgamation of customers into a common pool, for security models that protects the customer's data housed in a common pool, for infrastructures that either had a high entry price or limits in scalability, nor the inability to implement business models that were packagable and encouraged consumption growth. Traditional SSP business models failed to offer the fundament promise of offering its subscribers lower costs with higher qualities of service.

Key Challenges in the Service Provider Market

The unpredictable growth in storage demand, network bandwidth and the type of data customers store represent key challenges for SSPs. The increase in Internet events and resultant spikes in demand cause SSPs to over provision their infrastructure, making it difficult to achieve profitability. Time to market is a profitability pressure point for SSPs as customer demand in terms of the numbers and types of services offered is constantly changing. Factors affecting the service provider market, including volume and value of data, as well as storage management costs, are similar to enterprise challenges to a certain degree, but extend to different, more extreme dimensions for service providers.

Sheer Volume of Data

The increase in average file size (text-based to multimedia) continues to grow as Internet bottlenecks improve. Digital images, music, and video files are examples of particularly large files that are becoming prevalent. One minute of uncompressed video alone can require over two GB of storage capacity. New applications are also driving storage capacity upward and introducing new types of data. At the same time, Internet access devices, such as mobile phones and Personal Digital Assistants (PDAs), are getting smaller with less processing power, less storage, and smaller screen sizes. This trend implies that more content will have to be processed and stored on the Internet rather than within the access device.

To further fuel capacity requirements, storage is being used to replace bandwidth. In this scenario, files are often stored several times across the network. Storing data at the network edge (in multiple locations close to the end-user rather than at the network core site) means faster end-user response time and reduced bandwidth cost. Storage will replace bandwidth in locations where connectivity is poor or bandwidth costs are high. An increasing percentage of Internet content will be delivered from the edge of the network rather than from the core—meaning significant growth in storage.

Value of Data as a Corporate Asset

The growing importance of data as a corporate asset puts increasing pressure on IT organizations to protect and manage storage to ensure its continuous availability. Not only is traditional data proliferating, new types of data, such as streaming video, are becoming more mission critical. As organizations rely more heavily on data to give them a competitive advantage, the opportunity cost of lost data climbs to higher levels. The value of data also increases as new ways are found to process and analyze past and present data with data mining software.

Management Cost

Storage management tasks range from the mundane (finding and replacing failed disks) to the elaborate (service provisioning). Still a very human resource-intensive operation, storage management typically has an annual cost that is five to seven times greater than the capital cost of the storage itself. Recognizing that processor cycles are inexpensive but human cycles are costly, the most cost-effective choice for management is leverage processing power to automate labor-intensive management tasks. System self-management must support changing I/O patterns; multi-vendor environments in servers, software and networks; end-to-end management across geographies; and seamless compatibility with industry standards.

The accelerating complexity of the technology infrastructure also contributes to escalating storage management costs. In most enterprises, storage is not a core competency. As sites are faced with deploying larger and more complex storage infrastructure, management costs compound quickly and technology planning becomes riskier. The rapid evolution of technology mandates training of specialized personnel to maximize performance gains and ensure compatibility with emerging standards. To further exacerbate the problem, personnel with the storage management competency are scarce and expensive. As of 2001 there were close to one million unfilled IT positions in the United States. By 2003, this number could increase to over four million. (Sources: ITAA/Morgan Stanley Dean Whitter Equity Research)

Bringing New Services to Market

Service providers seek a variety of revenue sources to build healthy growing businesses. As long as they are limited to providing services that customers can provide for themselves, the possibility of significant margin enhancement is limited, as customers know what the service should cost. Service providers are experiencing growing market pressure to provide software-based services that will differentiate their offerings beyond what an enterprise can cost-effectively implement in-house. Further, new services must be implemented quickly and often have a shorter life duration. The ability to rapidly and flexibly deliver new services has become a matter of survival.

Infrastructure Challenges

Today, service providers are facing serious infrastructure, storage management and resource issues. Concerns that were once isolated to their customers are now key challenges for the SSP.

Unpredictable Demand for Capacity and Bandwidth

Because SSPs are generally serving multiple clients from shared resources, much broader fluctuations in capacity and performance may occur in their data centers. Unlike the traditional corporate data center where variability can be more readily forecasted, an SSP data center must be designed to simultaneously handle peaks and valleys from an aggregate of diverse customers. To profitably manage these fluctuations, an SSP may be prone to build in peak pricing for unplanned resource overages on the speculation that the customer will underestimate demand. This drives up revenue and margin, but may diminish an SSP's price competitiveness. Further, the SSP must be able to provision capacity at a moments notice. The challenge involves adopting technology that provides cost-effective expansion as well as sophisticated tools for usage accounting (billing), storage demand planning, and service provisioning.

Escalation of Technology Management Complexity

As operating architectures for linking numerous types of application, file, and database servers continue to evolve, the complexity of data storage access significantly increases. As this sprawling complexity rises, so does the need for greater business continuity assurances through rigorous Service Level Agreements (SLAs).

Quality of Service (QoS)

Most enterprise data center storage systems today provide reasonably predictable response times and data rates. When several customers share the same storage subsystem, it becomes much more difficult for the SSP to ensure specific levels of performance. A critical issue for many service providers managing several customers from the same infrastructure centers on the SLAs is the specific parameters they have contractually guaranteed their customers. It is imperative that when one customer demands more bandwidth for their application, it does not negatively affect other customers sharing the same infrastructure. Further, failure to uphold SLAs can result in financial damages and jeopardize customer retention.

Another critical issue facing service providers is that the servers attached to the storage network may deliver unpredictable QoS; they crash, they thrash. I/O channels or network connections fail. To achieve QoS targets, the storage management system must allow SSPs to quickly find and isolate faults so that server issues are correctly identified. In addition, streaming applications and web serving can frequently benefit from direct service from the (storage) array to the web, eliminating the server's QoS problems.

Reliability

Carrier-class storage needs to go beyond the simple “no single point of failure” concept of enterprise storage products. Carrier-class storage needs to survive “multiple points of failure” and offer “n-1” availability, where the systems continue to work, even after the failure of dozens or even hundreds of components. Even total site failures caused by natural disasters such as earthquakes, fire, explosion or tornado, should not lead to data loss or hinder availability. Maintenance should be simple, with a limited number of hardware components and modular and hot-upgradeable software. Massively scalable geographically distributed network storage can ensure business continuance for a truly disaster-proof environment complete with redundancy, sophisticated replication, backup and recovery.

Scalability

Scalability is perhaps the most overused and least understood word in storage technology. Frequently used by vendors to describe the “ability to increase storage capacity,” this word has a very different meaning for users—especially service providers. To users, scalability means: “Can I grow my system to meet new workloads, attach new systems and support new applications, in an easy, affordable and non-disruptive way?” An even simpler version of the question is: “Can I start small and grow to a large size without ever bringing down the system or throwing anything away?” From a customer's perspective, there are key several elements that need to scale. These elements include:

IOPS (Input/Outputs Per Second)—important for database systems.

Bandwidth—important for moving many large files and streaming media.

Connectivity—important for attaching more systems and disks.

Cache—important for maintaining performance as demand grows.

Capacity—needed to handle all the new data being generated and stored.

Manageability—important to simplify administration as the system grows.

Timely Deployment of New Services

One of the biggest issues an SSP faces today is differentiating their services from what the customers can themselves perform. Currently SSPs deploy storage equipment that was designed for the enterprise. Using the same equipment that their customers can buy and deploy themselves means that SSP services can differentiate on price and quality, but not on the content of the service itself. New value added services can only be offered with storage technology that has been designed from the ground up with the needs of the service provider at the forefront of the design cycle. The introduction of new services such as synchronous multiple site mirroring, remote snapshot copies, distributed WAN clusters for data and application availability, differentiated QoS, and data on demand can enhance revenue opportunities for SSPs, as can the ability to effectively deliver content across geographies. In addition to price and quality, SSPs are challenged to support an infrastructure that enables new services to be quickly provisioned and deployed.

It is therefore desirable to provide systems and methods that address the specific needs of SSPs and other providers, and which overcome many or all of the problems facing such providers as discussed herein.

### BRIEF SUMMARY OF THE INVENTION

The present invention provides novel systems and methods for delivering electronic data storage to consumers in an efficient, cost-effective way. A new storage networking paradigm, Utility Storage, is provided which addresses the specific needs of SSPs. Many characteristics of the Utility Storage model enable a new SSP business model to be implemented that is more profitable and growth orientated.

According to aspects of the present invention, a business method is provided wherein an SSP provides storage to an end customer with a low entry cost threshold that encourages incremental consumption by the consumer. According to other aspects of the present invention, a business method is provided wherein an SSP provides alternate storage services to a customer.

According to aspects of the present invention, a business method is provided wherein an SSP provides storage services to an end customer at a lower cost by amortizing the operating and infrastructure costs across a larger population of customers. According to other aspects of the present invention, a business method is provided wherein an SSP provides storage services to an end customer at a lower cost by amortizing the operating and infrastructure costs across a larger population of customers while maintaining security between customers.

According to an aspect of the present invention, a method is provided for providing electronic data storage to customers. The method typically includes providing one or more storage systems, each storage system including one or more storage devices, and providing a controller system including one or more storage controllers that provide customer access to the one or more storage systems, the controller system being communicably coupled to host customer systems over a network. the method also typically includes allocating a specific amount of storage space to a first customer for storage of the first customer's data, charging the first customer a first rate for the allocated amount of storage space, receiving customer data from the first customer for storage on the storage system, and storing the received customer data to the storage system. The method also typically includes charging the customer a second rate for the storage space used in excess of the allocated amount of storage space, wherein the second rate is lower per amount of storage space than the first rate, whereby incremental use of storage space is encouraged.

According to another aspect of the present invention, a method is provided for providing electronic data storage to customers. The method typically includes providing one or more storage systems, each storage system including one or more storage devices, the one or more storage systems being communicably coupled to host customer systems over a first network. The method also typically includes allocating a specific amount of storage space to each customer for storage of the customer's data, charging each customer a first rate for the allocated amount of storage space, receiving customer data from customers for storage on the storage system, and storing said customer data to the storage system. The method also typically includes, for each customer, charging the customer a second rate for the storage space used in excess of the allocated amount of storage space.

According to another aspect of the present invention, a method is provided for providing electronic data storage to customers. The method typically includes providing one or more storage systems, each storage system including one or more storage devices, and providing a controller system including one or more storage controllers that provide customer access to the one or more storage systems, the controller system being communicably coupled to host customer systems over a network. The method also typically includes allocating a specific amount of storage space to each of a plurality of customers, and dynamically determining, using the controller system, the actual storage location for customer data on the storage systems as customer data is received, wherein the physical location of the specific amount of storage space allocated to each customer is not determined until data is actually received and stored so that actual storage space is not allocated until data is stored thereto. In this manner, the costs of providing and operating the storage and controller systems are amortized across the plurality of customers, and the costs charged to customers for the use of the storage system are reduced.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 illustrates a storage mapping on demand architecture according to the present invention.

FIG. 2 illustrates a network configuration according to an embodiment of the present invention.

FIGS. 3-6 illustrate aspects of the billing and rating engine and the billing and rating GUI of the present invention.

### DETAILED DESCRIPTION OF THE INVENTION

Scalable Infrastructure

The present invention, in certain aspects, provides a profitable SSP business model that lowers costs by hosting many consumers from a common physical pool of storage, thereby amortizing the infrastructure costs across a larger population and lowering operations costs by managing a single large pool of storage rather than many smaller pools. In order to accomplish this objective, technology that allows a scalable storage infrastructure is provided.

U.S. Pat. No. 6,148,414, which is hereby incorporated by reference in its entirety, describes building a storage system in which multiple controllers interoperate to create a pool of storage controllers that all have access to a common backend pool of physical disks. In one aspect, additional controller blades (e.g., cards) are added, as required, to incrementally add the available storage processing power. In this way, the storage system can scale both in terms of the amount of physical storage under management, but also in terms of the processing power that manages and provides physical access to the storage.

Additionally, U.S. Patent No. 6,148,414 describes a scalable availability and fault tolerance model. For example, write-back operations can be replicated across the independent caches of multiple controller blades. In this manner if the write is replicated to N blades, N-1 blades could fail without losing data resulting from the write operation. Additionally, all but one controller blade could fail without the system losing access to back-end physical storage.

Additionally, U.S. Pat. No. 6,148,414 describes a method whereby the individual caches of the controllers are pooled. This prevents cache ‘hot spotting’, where the system's performance, as seen by individual consumers, is greatly degraded due to access behaviors of other customers monopolizing the resources of individual blades.

In certain aspects, the modular blade level implementation allows an SSP to incrementally grow the infrastructure in response to real, rather than speculated, consumption growth. It allows the SSP to provide SLAs to the customer base that does not depend on isolating customers from each other. Scalable fault-tolerance allows pooling of all customers in a common storage pool without risk of individual component failures shutting down customers. Scalability is a core aspect to providing a profitable SSP business model.

Storage Virtualization, Auto-provisioning, Auto Policy Management

Currently, storage providers and storage solution providers use a one-to-one method of virtualization where each virtual block of data is mapped to a single physical block of data. SSPs are developing large customer bases, potentially in the millions, so manageability, maintenance, and cost are major concerns. SSPs also have to provide for the data expansion requirements of their customers.

Because it takes time to acquire, physically configure and/or re-partition disks, and to copy data to the new disks when storage needs change, expanding customer storage needs are often expensive and labor intensive. In addition, customer separation, which ensures customer data remains secure and completely separate from the data of other storage customers, adds to the maintenance burden. With traditional “separation” mechanisms such as Logical Unit Number (LUN) masking, physical isolation, and separation of management, “customer separation”, can quickly become unwieldy and impractical—creating a maintenance and support nightmare.

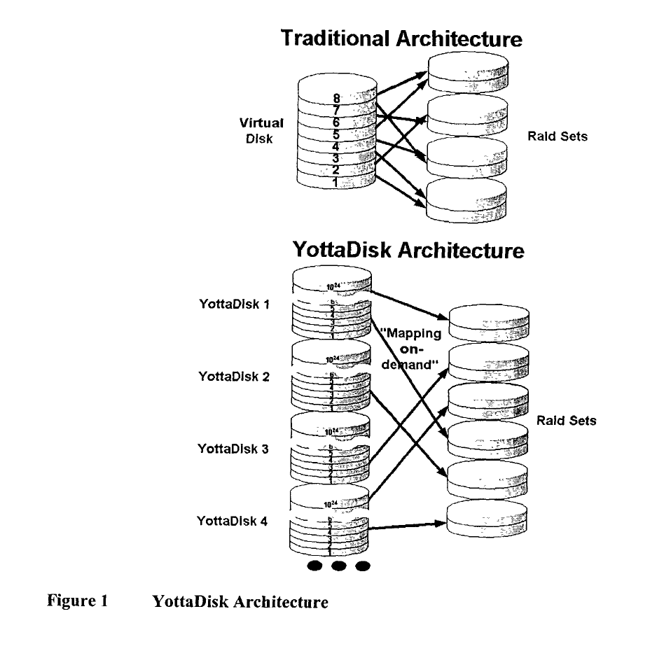

U.S. patent application Ser. No. 10/046,070 (Publication No. US-2002-0112113-A1), previously incorporated by reference, describes a novel approach to virtualization, wherein the virtualization system allocates physical storage from a storage pool dynamically in response to host I/O requests, e.g., SCSI I/O requests, allowing for storage resources to be amortized through the disk subsystem while maintaining coherency among I/O RAID traffic. The demand mapped disk images described in U.S. patent application Ser. No. 10/046,070 (hereinafter generally termed the “YottaDisk™” or “YottaDisk”) may look like “regular” virtual disks, each with a set of N contiguous blocks of storage; however, a YottaDisk is much larger than a regular virtual disk, for example, with a total size of 1.5 Yottabytes. This is made possible through the use of 80-bit addressing (in contrast to the maximum 64-bit addressing used by “regular” disks). Naturally, systems that only support 64-bit addressing that are using YottaDisks as raw block devices can use smaller YottaDisks. FIG. 1 illustrates an example of a demand mapped storage system, e.g. YottaDisk, according to the present invention. Additional reference is made to U.S. patent application Ser. No. 10/046,070.

Like “regular” virtual disks, YottaDisks can also be used with RAID sets; however, a major difference exists between “regular” virtual disk architecture and YottaDisk architecture. With the YottaDisk there is no pre-defined mapping to real disks when the YottaDisk is assigned to the customer. Instead, the YottaDisk is “empty”. A mapping to a real disk is created only when a particular disk block on the YottaDisk is referenced. When a disk block becomes unused, the physical block is freed and returned to the pool of free blocks.

The YottaDisk approach has several key advantages. First, host applications never have to deal with volume resizing. Second, spare capacity (or “slack space”) can be amortized across multiple YottaDisks, thus lowering the cost associated with “on reserve” storage capacity. Third, in a distributed implementation, data can always be written with “local” performance, even though other parts of the YottaDisk are housed at remote locations. Fourth, this provides an on-demand revenue model opportunity for SSPs. Further, it allows the automation of provisioning and the policies associated with these operations.

Traditionally, restriction of disk growth has been implemented by restricting the size of disk partition available. YottaDisks allow an easy interface whereby the user, the customer administrator, and (if appropriate) the SSP administrator can throttle disk consumption and impose limits. Charge back, the method whereby an IT department “charges” other internal departments for the use of centrally supported resources, can reflect actual storage usage.

It is important to understand that virtualization is purely a mapping operation. It is completely independent of how cache is managed and fault tolerance is achieved. It is also possible to restrict the mapping to specific physical volumes to allow traditional approaches to data security.

From a support perspective, the YottaDisk provides a highly tunable environment. Studies have shown that only a small portion of stored data is active at any one time. This allows optimization of performance by reorganizing data placement across devices to ensure “active data” is evenly distributed across as many devices as possible. This ensures that as many disk heads as possible are perusing data at any given time. Spreading large block files across many devices also allows for the greatest possible degree of parallelism in disk access. Spreading large streams of active data as widely as possible across a set of storage disks optimizes the effective performance and avoids access bottlenecks.

The abstraction provided by the YottaDisk also allows automatic tuning, based on access tendencies, of performance issues such as data placement, RAID types and stripe length.

For SSPs, to provide a cost effective service to the end customer, the costs associated with support staff should be amortized across many users. With current approaches to customer separation, each customer must be managed individually. The resulting support cost is only marginally less than in-house solutions. More important, it imposes a fundamental limit to the scalability of the business model based on a limited ability to recruit skilled talent.

A YottaDisk can be self-managed by the customer. The management of the physical backend storage is amortized across all customers. This dramatically increases the number of customers and the amount of storage an individual analyst can support. In addition, the YottaDisk can be shared and is coherent across multiple servers. Customers can simultaneously access their own YottaDisk from multiple locations and/or via multiple servers. From the customers' perspective, they have one disk—“A YottaByte for Life™”, regardless of the mapping, and re-mapping that occurs behind the scenes to support the YottaDisk.

While traditional “fixed” SSP revenue models can be supported, aspects of the of the present invention provide a number of unique revenue models.

In one embodiment, for example, a “Storage-on-Demand” usage model is provided. For example, implementation of a YottaDisk system allows demand-based consumption of storage. This further allows a low entry cost to consumers that inspires addictive consumption habits simply because using storage is easy. With the YottaDisk implementation, storage can become a true utility like power, water, and the telephone service—it is simply there when you need it, consumption is simple, and usage growth is natural.

In another embodiment, storage plans, based for example on capacity, are sold to customers. This is somewhat similar to typical cell phone usage plans. For example, customers can sign up for a fixed rate plan provided that their storage consumption does not exceed predetermined thresholds. A premium is charged when the customer exceeds the contracted capacity. With such a plan, SSPs can oversell capacity, since the majority of customers will typically be well below contracted capacity. For example, SSPs can charge a certain rate or a lump sum for a fixed amount of storage space, but when the allocated storage space is exceeded, a rate based on incremental storage can be charged, e.g., a per excess MB or per excess GB rate.

Integrated Security

One traditional approach to “user separation” and data security employs a mechanism known as LUN masking and/or the physical separation of storage into separate “islands”. Although this system works, it involves significant data center management overhead in the management of multiple independent pools and the assignment and maintenance of LUNs. Unless carefully configured and managed, the LUN based strategy for customer separation and security is also susceptible to intruder attacks.

LUN masking technology lets each client, or server, privately own portions of the storage system's capacity while concealing it from other attached servers. This means that each server has its own “secure” storage areas and eliminates the possibility of corruption by other servers connected to the same storage resource. Because each server has its own allocated storage space, the servers can be running different operating systems and file systems. This feature is key to delivering true centralized storage and is one of the founding technologies employed by SANs.

Even with LUN masking, customers must be placed on to separate storage allocations described by the LUNS. Fundamentally, traditional approaches to customer separation prevent managing multiple customers from a common pool of storage without risk of unauthorized access to data or data vandalism.

U.S. patent application Ser. No.10/198,728, “Network Security Devices and Methods”, filed Jul. 16, 2002, which is hereby incorporated by reference in its entirety, describes network security aspects which can be used in the Utility storage model of the present invention. In certain aspects, data security is addressed at four levels via mechanisms that may be optionally deployed:

Ensuring proper user authentication and policy application before allowing access to data or control paths.

Ensuring secure delivery between the controller, e.g., NetStorager, and client computer.

Encryption of data and metadata on disk.

A fortified architectural ring that encloses and protects controller, e.g., NetStorager, management, security and policy administration, virtualization, and the file system.

To address the need of SSPs for user separation and data security, each storage controller, e.g., NetStorager card, includes an optional (“in-stream”) encryption engine that can be employed to automatically encrypt/decrypt data as it is written-to, or read-from a YottaDisk. The encryption layer is designed to accommodate any encryption approach including hardware-supported encryption (e.g., through the use of a Field Programmable Gate Array (FPGA)). In addition, the CPU power and memory on the NetStorager card support multi-pass encryption algorithms. In certain aspects, a NetStorager card, supplied by Yotta Yotta Inc., is useful for implementing various controller card features as described herein and in U.S. Pat. No. 6,148,414. Where a NetStorager card is specifically referred to herein, it should be understood that any other controller card or network device may be used to implement the controller functionality referred to.

Both the data, and the file system structures that contain the data, can be encrypted. This way, if all of the security mechanisms were circumvented (accidentally or deliberately), an unauthorized user would not be able to read the data of another user, determine its structure, or determine the data's owner even if connected directly to the storage. This also protects against data exposure on disk units removed from the data center without being properly erased (such as a disk being returned on warranty after a failure).

Encryption of data for transmission over a non-secure medium (such as the Internet) is also supported by the NetStorager technology. Like storage level data encryption, the hardware support is provided for optimal performance. In a networking environment, standard secure tunneling protocols are also supported.

When Utility Storage is deployed in multiple locations as described in the Geographically Distributed Storage section below, the communication conduit between remote Utility Storage Clusters is also protected.

The security model described in U.S. patent application Ser. No.10/198,728, provides a number of security options, including for example:

1) In-band control commands may be selectively (on a command by command, port by port basis) disabled.

2) NetStoragers have built-in Ethernet ports that are used to create a separate, secure network for out-of-band control commands.

3) For systems using Fibre Channel to connect hosts, each NetStorager has sufficient Fibre Channel ports to allow a complete separation of the host side Fibre Channel fabric from the “trusted” disk side fabric.

4) The NetStoragers do not execute any user code, thus preventing virus attacks on the File System (e.g., YottaFS), encryption engines, virtualization engine, RAID systems, cache systems, coherence engines, or other NetStorager systems.

5) Optional dual-redundant storage management servers can operate within the secure network and can provide authenticated access via standard firewalls for management by SSP Global Network Operational Centers (GNOC) or by enterprise management staff.

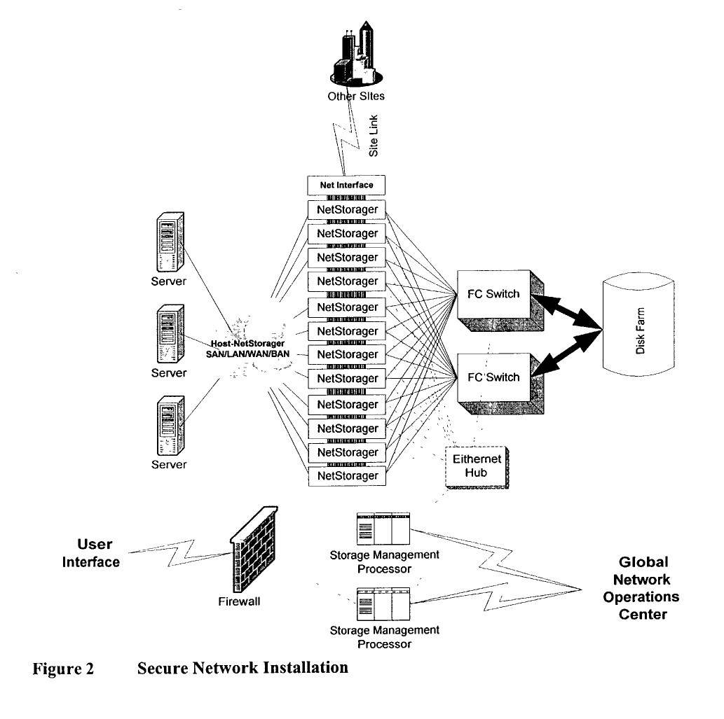

In a preferred network configuration described below and shown in FIG. 2, there are effectively six independent networks as follows:

Client Data Network: the host connection that connects client computers (data consumers) to the storage controllers, e.g., a NetStorager Cube or array. The host connection includes Fibre Channel, Infiniband, or some type of network technology connected directly into the NetStorager Cluster. This network may, or may not, be considered physically secure depending on the application. If it is unsecured, then it can be protected via the methods described above.

NetStorager Cluster Network: This is a private network that is used for inter-NetStorager connections within a site. In certain aspects, a private Infiniband network is used, although other networks may be used.

Secure Fibre Channel Fabric: This is a switched Fibre Channel network that connects NetStoragers to physical disks.

The Secure Storage Management Network: This optional Ethernet network connects out-of-band storage management ports on NetStoragers, Ethernet connections on Secure Fibre Channel Fabric switches, and the dual-redundant storage management processors. Access to the GNOC networks (described below) and customer side management clients (HTTP clients) is provided through secure tunnels and firewalls.

GNOC Access Network: A tunneled bridge from the Secure Storage Management Network to the GNOC.

Inter-NetStorager Cluster Network: This network connects NetStorager Clusters that are geographically separated, and may include a private network, point-to-point Dense Wavelength Division Multiplexing (DWDM), a logical private network implemented on public networks via a secure tunnel, etc.

It should be understood that many variants of this architecture can be employed to address variants in requirements.

Billing and Rating

Traditionally, SSPs have billed based on selling blocks of storage to a customer. This block of storage can grow over time; however, the dimensions of revenue opportunity are very limited.

The Utility Storage System described herein in one embodiment allows for a variety of statistics to be collected and attributed to individual users. These statistics can be used to determine revenue billing models against individual customers. Examples of such statistics include:

Amount of data resident on the physical disk

Number of bytes read or written

Number of I/O operations

Utilization of cache

Write replication levels

Mirroring level of storage

Premiums for data placed of fast access devices, discounts for data placed on archive devices

Geographic replication strategy (see below)

Host interconnect speeds

Snapshot and cloning operations (e.g., described in U.S. patent application Ser. No. 10/046,070)

Customers can also be charged for other value-added services such as high fault-tolerance levels, geographic distribution, QoS and mirroring levels. In addition, special services can be offered that are tied to the availability, performance and QoS levels required for the data. These might include cache replications, remote mirroring and protection against M failures (where M is greater than 1). As will be described in later sections, these attributes are specified at a file level, with defaults being set for YottaDisks, and can easily be changed by customers at any time. The result is a value-add revenue model that is easy to consume, and plays on a customer's need for conveniences and fear of data loss

Billing and Rating Engine

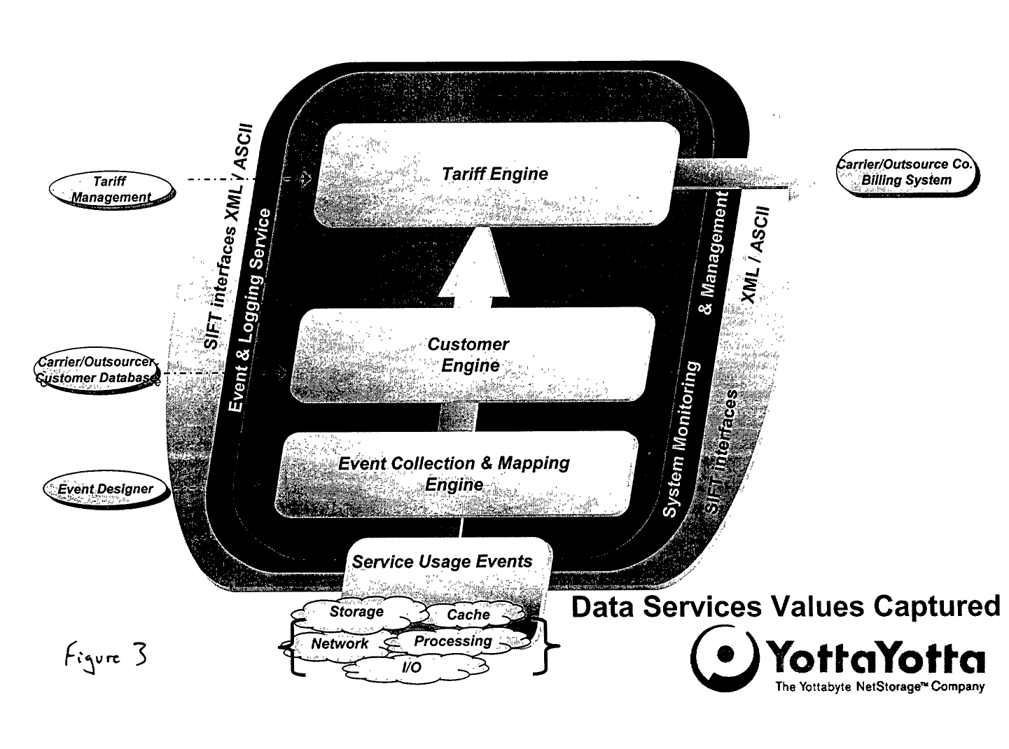

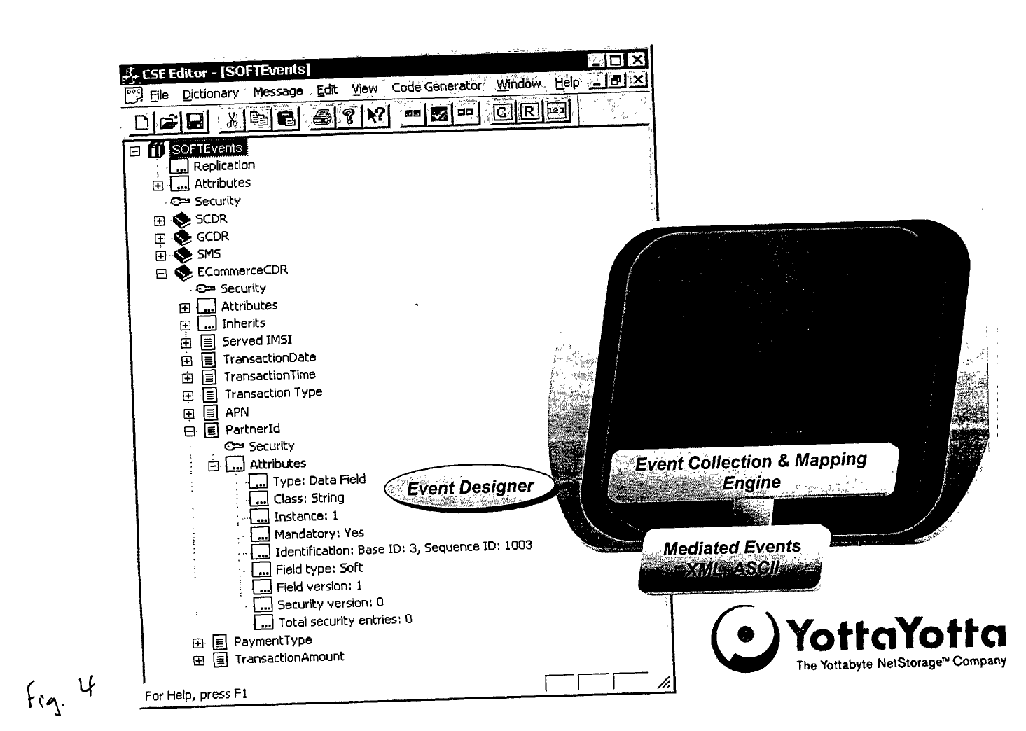

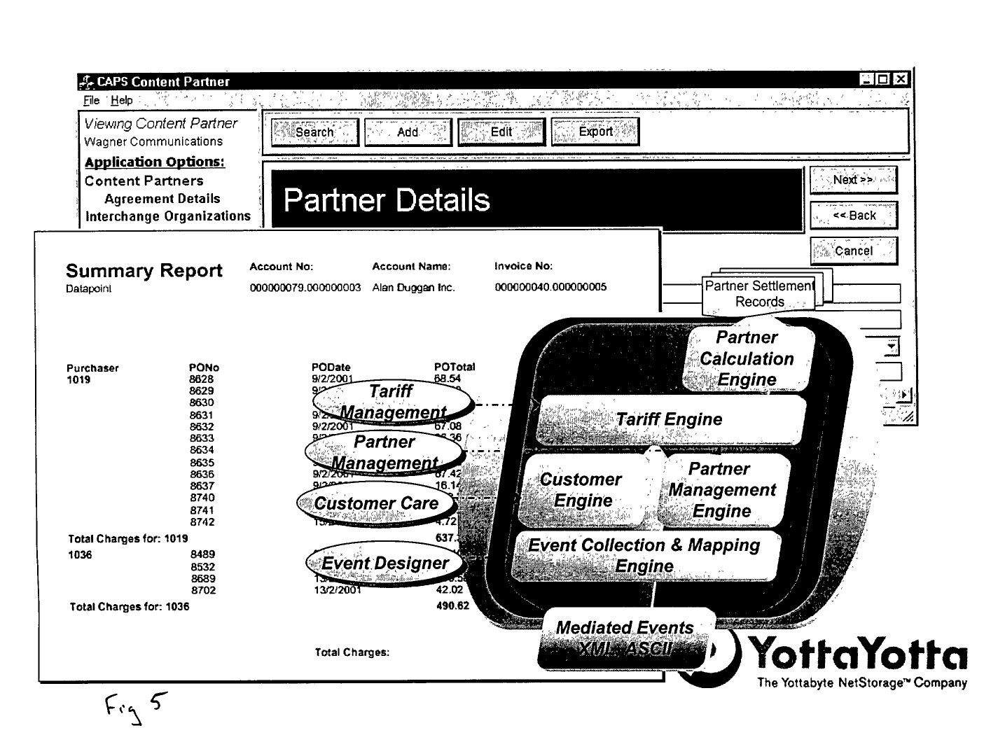

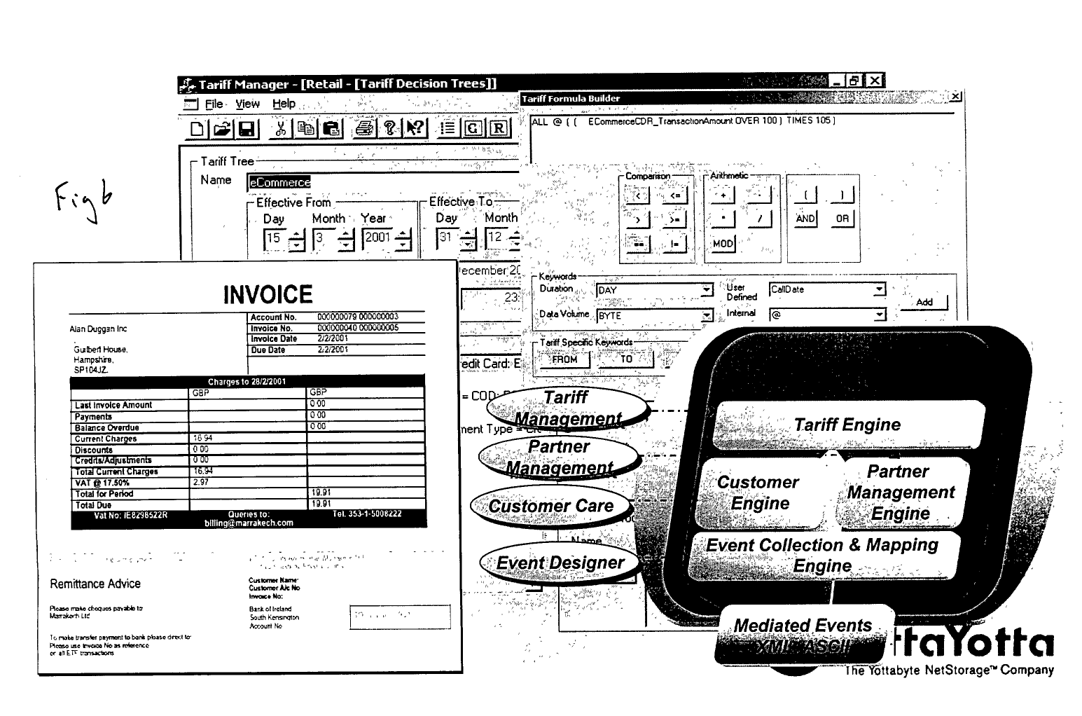

According to one embodiment, a billing and rating engine is provided. the billing and rating engine of the present invention utilizes aspects of the Utility Storage System described herein. The Billing and Rating engine allows an SSP to take the individual statistics described above, classify them, process them based on different billing packages that may be offered to individual customers, print an invoice and feed the results into a larger billing system. FIGS. 3-6 illustrate aspects of the billing and rating engine and GUI of the present invention.

The system collects the raw statistics and exports them through an ASCI stream to a computer running the Billing and Rating Engine.

A Graphical User Interface (GUI) is provided to allow the SSP (e.g., user or administrator) to classify events; example of GUI windows are shown in the Figures.

In certain aspects, users can use the GUI to create different billing packages. For example, in one embodiment, a package is devised that is based on a ceiling of storage usage growth and storage access. If a customer exceeds these amounts, the customer is charged a premium. Rates for these packages can be assigned. Add-on services, such as site replication, can also be charged for. The result is billing records are archived on the billing computer.

The system allows the SSP to experiment with ‘what if’ games using different billing models. In the end, the resulting billing information can be used to produce actual invoices or to feed into other accounting systems. The Billing and Rating engine of the present invention allows for revenue models similar to those that have made the telephone industry profitable.

Geographic Support

Today's companies have large amounts of data housed in data center locations all over the world. Unfortunately, these data centers are managed individually as “islands of storage”. Such islands of storage tend to limit the collaboration of employees across locations and inhibit the productivity of traveling employees. Each center must be individually managed and maintain reserve capacity.

The cost of down time for many data centers is measured in millions of dollars. The loss of key data due to data center disasters may not even be measurable. Increasingly, corporations are looking to geographically replicate data to ensure a quick operational recovery in the event of the unexpected availability of a data center. Current technology for remote data replication works at the volume level and, therefore, is expensive, operationally inflexible, extremely demanding on network resources, and prone to application level data corruption.

SSPs currently have two strategies. One strategy is to put all storage hardware within the customer site. This implies a high initial capital cost and no ability to amortize reserve capacity and management costs across clients. The second strategy is to provide all storage in a centralized data center remote from the client's infrastructure. This causes all data accesses to be over a network, which significantly impedes performance.

Content distribution engines that accelerate the distribution of media rich material across the Internet are increasingly used. They function by caching reads of contents at points close to the Internet edge so that subsequent requests can be serviced from cached images that are geographically close to the requester. An SSP requires a similar support strategy for the delivery of file information that addresses both the read and the write operations.

According to one embodiment, the Utility Storage system of the present invention can be deployed in multiple geographically separated locations. The resulting “meta data center” provides users with a single data image. The Utility Storage system enables distributed direct access without storage bottlenecks and provides scalable, distributed networked access with extreme data rates and massive data volumes without performance degradation. Data can be selectively (e.g., at a file granularity) geographically replicated with the importance of the data determining how far the data is replicated, the synchronization method of replication, or whether the data is replicated at all.

The link connecting sites can be one of a variety of network technologies—the choice of technology dictates the overall performance and bandwidth. This link could be a dark fibre connection, it could be a switched packet frame, or it could be the Wide Area Network (WAN).

Basically, geographic deployment addresses two key requirements: distributed data access and data replication.

Distributed Access

In certain aspects, if a file is commonly used in a single location, the system will locate the physical data at that location. Other locations can, however, still access this data. The first time the data is referenced, a copy of the data is moved to the referencing site. As a result, there is a network-induced delay while the initial block of a file is referenced, but other blocks within the file are prefetched allowing local access performance. The system recognizes files that are commonly accessed at multiple locations and automatically replicates copies of the underlying data blocks to ensure fast access.

In certain aspects, the system also supports multiple writers to the same data set. Both file and byte level synchronization is supported. The system hides the latency of multiple writers by merging written images only after locks have been released.

Remote Replication

In the past few years, the demand for remote replication solutions has been enormous. Originally, this could only be done by creating local mirrors of data, periodically taking a mirror offline, copying the offline mirror to a remote volume, updating the local mirror and bringing it back online. This approach requires three to four times the data storage and leaves large opportunities for data loss. A synchronous mirror can be created remotely, however, this only works if the replication distance is small (small latency). More recently, an asynchronous replication approach has been available where every write is written, in the order of the writes, to a remote volume. This still leaves a significant window for data loss.

A key disadvantage of current solutions is that replication is done at a volume level—every byte of data is treated the same whether appropriate or not. Additionally, the target volumes must be physically the same as the originator. These issues cause significant maintenance difficulties for both the data center administrator and for the end consumer.

With the Utility Storage System of the present invention, the behavior of replication can be specified at a file level. Key files can be synchronously replicated while less important files can be asynchronously replicated. Unimportant files may not be remotely replicated at all. The file behavior can easily be changed at any time.

In certain aspects, replication is also done at the YottaDisk level. The remote copy resides within a pool. This removes the restriction of copies being the same size and optimizes the utilization of storage resources.

Additionally, the system is geographically aware. In certain aspects, a file can be synchronously replicated to a center close by and then asynchronously replicated to further distances. Users can specify the number of sites to replicate the file, or specific replication sites.

The system also provides support for “point-in-time copy” of data. The copy can then be accessed as an alternate YottaDisk.

Distributed Operations Support

The Utility Storage System of the present invention not only allows data users a virtual single site, but also allows the distributed operation to be managed as a single site.

From an SSP perspective, storage is manageable from a single point and because the storage management system is configured as a web-based interface, that single management point can move at any time. A virtual volume of data can be created, expanded, deleted, moved and selectively presented to a server operating system in a manner that is independent of the storage device on which it resides. Referring to the data center example of a data center in New York and another in Boston, the system administrators in New York and Boston can view the same management interface with the appropriate access controls in place. Their physical location is irrelevant; the data can all be managed as a ubiquitous resource.

Similarly, from the users perspective (at the virtual layer), the storage solution of the present invention manages the virtual perspective of this distributed data as a uniform, unified resource. Additionally, the customer (the end user in the data center) can control the behavior of the file at the virtual level. This file management is accomplished at the software layer without any physical effort, i.e., without the plugging of cables or the manual copying of disk drives.

Integrated Feature Set

Core to the success of a new SSP business model is to implement some or all of the technology features described above in an integrated system. While other approaches may be used to provide these benefits in isolation, it would be advantageous for an SSP to integrate all of these features. For example, it makes little sense to provide performance scalability if security is layered in front of the system becoming the bottleneck.

Additionally, by implementing the features into the storage system, the SSP does not need to manage software that would traditionally have to be installed on customer computers to provide services such as virtualization.

A New Business Model

The above technologies allow the deployment of a new SSP business model. The new SSP model of the present invention has similarities to those used by the cell phone industry. Customers are sold SLAs based on their expected disk consumption. YottaDisks are provided to the customer, which allows the customer to consume storage by simply using it. YottaDisks also allow the storage to be subscribed in that all consumers will not instantly use all of the storage available to them (e.g., similar to the power company model). YottaDisks allow users to painlessly consume more—they just have to use it.

The Utility Storage System described above allows the delivery of storage services at a lower cost than could be achieved by the customer because of the amortization of costs across a larger user base and because of the reduction in total reserve storage (empty storage).

The geographic support allows a more effective approach to business continuity, the ability to amortize costs across sites as well as across customers, and the ability to provide customers a new, common view, of data. It also allows a hybrid of managing storage within a customer's site as well as within a centralized location, a feature key to the migration from in-house data to centralized managed storage services. This feature also allows profitable outsourcing of high-traffic, latency sensitive data.

Implementation of aspects of the present invention advantageously provides an SSP with many Return on Investment opportunities, including:

| ROI Factors | Carrier-Class Storage Advantages |
|---|---|
| Management Costs | Reduces management costs by presenting the storage |
| | network as a single virtual entity |
| | Integrated SAN and NAS elements reduce network |
| | complexity and can be centrally managed |
| | Automated storage management processes alleviate |
| | demand for skilled personnel and reduce risk of human |
| | error |
| | Reporting and billing systems support SLAs, provide |
| | usage tracking and generate new revenue streams |
| | Service provisioning tools maximize infrastructure |
| | investment and permit new services |
| Acquisition and Scaling Costs | Minimal entry-level capital expense, along with lower |
| | operating costs, can cut SSP time to profitability in half |
| | Capacity constraints eliminated |
| | High level of granularity at low cost removes barriers to |
| | scaling |
| | True multi-dimensional system scaling in performance, |
| | capacity, availability, manageability and geographic |
| | distribution |
| | Massively parallel cluster networks embedded in the |
| | core system provide seamless scalability |
| | Virtualization techniques utilize all available capacity, |
| | thus deferring expansion costs and saving footprint |
| High Availability and Business | Securely provisioned and geographically distributed |
| Continuance | storage for disaster recovery |
| | Built-in snapshot and mirroring capabilities and |
| | automatic data migration services for immediate |
| | replication and data restoration |
| | Advanced in-stream encryption engine for maximum |
| | secunty |
| QoS and Performance Consistency | Dramatically decreases response time and increases |
| | system performance by transparently bringing |
| | information to the edge of the network and closer to the |
| | user |
| | Attributes of shared storage pool can be customized for |
| | individual subscribers |
| | Architecture to handle fluctuations in demand ensures |
| | customer satisfaction |
| Profitable New Business | Reduced costs through consolidation and economies of |
| Opportunities | scale |
| | Embedding commonly purchased services; such as |
| | mirroring and replication, enables service providers to |
| | improve margins by offering these services at a lower |
| | cost |
| | Enables faster time to market with new differentiated |
| | services such as synchronous multiple site mirroring, |
| | remote snapshot copies, and distributed WAN clusters |
| | for data and application availability |
| Technology Risk | Architected from ground up to adopt new network |
| | protocols and provide extended flexibility |
| | Infinitely scalable, massively parallel, geographically |
| | distributed architecture eliminates growth penalty |

The following additional Patents and Patent applications, each of which is hereby incorporated by reference in its entirety, disclose technologies and features that are useful for implementing, and incorporating into, the Utility Storage model and other aspects of the present invention:

U.S. Pat. No. 5,875,456;

U.S. patent application Ser. No. 10/006,929, filed Dec. 6, 2001 (atty docket 019417-000120US);

U.S. patent application Ser. No. 09/815,824, filed Mar. 22, 2001 (atty docket 019417-000210US); and

U.S. Provisional Patent Application Serial No. 60/333,996, filed Nov. 28, 2001 (atty docket 019417-005500US).

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of providing electronic data storage to customers, comprising:
providing one or more storage systems, each storage system including one or more storage devices;
providing a controller system including one or more storage controllers that provide customer access to said one or more storage systems, said controller system being communicably coupled to host customer systems over a network;
allocating a specific amount of storage space to a first customer for storage of the first customer's data;
charging the first customer a first rate for the allocated amount of storage space;
receiving customer data from the first customer for storage on the storage system;
storing said customer data to the storage system; and
charging the customer a second rate for the storage space used in excess of the allocated amount of storage space,
wherein the second rate is lower per amount of storage space than the first rate, whereby incremental use of storage space is encouraged.

2. The method of claim 1, wherein the first rate charged to each customer is a lump sum amount based on the amount of allocated storage space.

3. The method of claim 1, wherein the physical location on the one or more storage devices to which the first customer's data is stored is dynamically determined by the controller system as the customer data is received for storage.

4. The method of claim 1, wherein the second rate is an incremental rate based on the actual amount of excess storage space used.

5. The method of claim 4, wherein the incremental rate is based on MB storage increments.

6. The method of claim 4, wherein the incremental rate is based on GB storage increments.

7. A method of providing electronic data storage to customers, comprising:
providing one or more storage systems, each storage system including one or more storage devices, said one or more storage systems being communicably coupled to host customer systems over a first network;
allocating a specific amount of storage space to each customer for storage of the customer's data;
charging each customer a first rate for the allocated amount of storage space;
receiving customer data from customers for storage on the storage system;
storing said customer data to the storage system; and
for each customer, charging the customer a second rate for the storage space used in excess of the allocated amount of storage space.

8. The method of claim 7, further including providing a controller system including one or more storage controllers that provide customer access to said one or more storage systems, said controller system being communicably coupled to host customer systems over said first network and to said one or more storage systems over a second network.

9. The method of claim 8, wherein the physical location on the one or more storage devices to which each customer's data is stored is dynamically determined by the controller system as customer data is received for storage.

10. The method of claim 7, wherein the second rate charged to each customer is an incremental rate based on the actual amount of excess storage space used by that customer.

11. The method of claim 7, wherein the second rate charged to each customer is lower per amount of storage space than the first rate, whereby incremental use of storage space is encouraged.

12. The method of claim 7, wherein the first rate charged to each customer is a lump sum amount based on the total amount of allocated storage space.

13. A method of providing electronic data storage to customers, comprising:
providing one or more storage systems, each storage system including one or more storage devices;
providing a controller system including one or more storage controllers that provide customer access to said one or more storage systems, said controller system being communicably coupled to host customer systems over a network;
allocating a specific amount of storage space to each of a plurality of customers;
dynamically determining, using the controller system, the actual storage location for customer data on the storage systems as customer data is received, wherein the physical location of the specific amount of storage space allocated to each customer is not determined until data is actually received and stored so that actual storage space is not allocated until data is stored thereto, whereby the costs of providing and operating the storage and controller systems are amortized across the plurality of customers, and whereby the costs charged to customers for the use of the storage system are reduceable.

14. The method of claim 13, further including providing security measures to prevent customers from accessing the data of other customers.
